(19) United States
(12) Patent Application Publication
(10) Pub. No.: US 2015/0021859 A1
(43) Pub. Date: Jan. 22, 2015

(54) SEALING APPARATUS FOR APPLYING CORROSION PREVENTION COMPOUND IN THE GAP BETWEEN PIPE FLANGES WITHOUT USING HEAT

(71) Applicant: PTT Public Company Limited, Bangkok (TH)

(72) Inventors: Cheeraporn Ananthanawat, Bangkok (TH); Ungkana Wongsiriwan, Bangkok (TH); Patchareeporn Sintoorahat, Bangkok (TH); Chamlong Prabkeao, Bangkok (TH)

(73) Assignee: PTT PUBLIC COMPANY LIMITED, Bangkok (TH)

(21) Appl. No.: 14/334,751

(22) Filed: Jul. 18, 2014

(30) Foreign Application Priority Data
Jul. 19, 2013 (TH) 1301004014

(51) Int. Cl. F16L 23/16; F16J 15/02

(52) U.S. Cl. CPC F16L 23/16; F16J 15/021
USPC 277/314; 156/349

(57) ABSTRACT

Sealing apparatus for applying corrosion prevention compound in the gap between flanges without using heat consists of 3 units including hydraulic power unit, compound injection cylinder unit, and flange belt unit. The present invention is used to apply corrosion prevention compound in the gap between flanges without using heat for melting the compound before sealing. The compound injection cylinder unit comprises two integrally formed cylinders sharing one connecting rod wherein the lower cylinder defines the hydraulic cylinder and the upper cylinder defines the compound injection cylinder. The compound injection cylinder unit is vertically formed on a pushcart provided with wheels for manual transportation. A threaded coupler is provided on top of the lid of the compound injection cylinder for connection with a hose for transferring the compound to the inlet on the flange belt unit. The flange belt unit is provided in various diameters from 2-24 inches. The application of corrosion prevention compound in the gap between flanges is carried out by applying the pressure from the hydraulic cylinder powered by the hydraulic power unit to inject the compound in the cylinder through the hose into the gap between the flanges of pipes.

### FIELD OF THE INVENTION

This invention relates to a sealing apparatus for applying corrosion prevention compound in the gap between flanges without using heat.

### BACKGROUND OF THE INVENTION

In transferring fluids, i.e. liquid or gas, from their production sources, pipes are the most preferred method. A number of pipes need to be connected for conveyance of fluid to distant destination. In such connection, a number of flanges are needed. It is possible that environmental dampness will be accumulated in the gap between flanges and corrosion may occur on the flanges and their nuts. The prevention of flange corrosion can be done in many ways. It is mostly done by paint coating, however, one disadvantage is that even a small crack will allow dampness to enter and induce rapid corrosion which is hardly observable. Another method is to use adhesive tape which also doesn't provide effective prevention against corrosion as moistness can be accumulated and forms droplets which are detained in the gap between flanges and in turn generates corrosion. A tool for covering and attaching the flange can be used to prevent liquid splash out of the pipe when there is a leakage and to prevent corrosion. Such attachment has to be air-tight so as to prevent flange's exposure to air and it needs to be permanently fixed, therefore it is relatively costly. In addition, corrosion prevention compounds or materials can be used to seal the gap between flanges. Preferable compounds and materials include substances which are solid or semi-solid at room temperature but become liquid when heated. Apparatus for injecting such substances is developed according to U.S. Pat. No. 5,955,020 comprising a corrosion prevention compound, a mantle of heating, a syringe with removable injector and an adhesive tape for application on pipe. Its method of use comprises the steps of: winding the adhesive tape around the flange, punching the tape to create substance inlets and air ventilations, heating the corrosion prevention compound to melt it using the mantle of heating in a container, using the syringe to suck up the molten compound and injecting it into the premade hole, and removing the adhesive tape and cleaning the surface. Since the apparatus and method requires heating for melting the compound to be used in sealing, it becomes quite complicated and dangerous in their application in petroleum production and transportation sites where heat utilization is limited. They are also not suitable for large flanges, and the tape can get peeled off during injection. The present invention therefore provides a sealing apparatus for applying corrosion prevention compound in the gap between flanges without using heat for melting the compound. Instead, hydraulic system is used in the injection operation. Therefore, it is applicable with pipe flanges of all sizes, big or small. Also provided herein is a flange belt unit specifically designed to substitute the use of adhesive tape. Therefore, the application of compound can be carried out quickly and safely, and the corrosion prevention compound is applied uniformly in the gap between flanges. The effective corrosion prevention thus can be ensured.

### SUMMARY OF THE INVENTION

The sealing apparatus for applying corrosion prevention compound in the gap between flanges without using heat according to the present invention comprises a compound injection cylinder vertically placed on a pushcart provided with wheels for convenient transportation, a hydraulic cylinder provided below the compound injection cylinder, wherein the upper end of the connecting rod is integrally formed with the piston of the compound injection cylinder, a lid provided on top of the compound injection cylinder for charging the corrosion prevention compound into the compound injection cylinder, a threaded coupler provided on top of the lid of the compound injection cylinder for connection with a hose for transferring the corrosion prevention compound to the inlet on the flange belt, the flange belt's diameter varying from 2-24 inches. The injection of the corrosion prevention compound into the gap between flanges is carried out by applying the pressure from the hydraulic cylinder powered by the hydraulic power unit to inject the compound in the cylinder through the hose into the gap between the flanges of pipes without requiring heat to melt the compound before injection. The amount of the compound left in the injection cylinder can be monitored via the pressure gauge on the injection cylinder.

The objective of the present invention, i.e. the sealing apparatus for applying corrosion prevention compound in the gap between flanges without using heat, is to provide a tool for applying a semi-solid corrosion prevention compound having high viscosity at room temperature in the gap between flanges without applying heat in melting. Said compound application will prevent environmental moistness and dirt from entering and accumulating in the gap between pipe flanges and prevent vapor condensation in the gap between flanges. Such moistness and dirt may corrode the flange and the nut used in fixing and thus cause damages.

### BRIEF DESCRIPTION OF THE DRAWINGS

FIG. 1 illustrates the assembly of the sealing apparatus for applying corrosion prevention compound in the gap between flanges.

FIG. 2 shows the components of the hydraulic power unit.

FIG. 3 shows the components of the corrosion prevention compound injection cylinder unit.

FIG. 4 shows an example of the flange belt unit for 10-24 inches diameter pipe.

### DETAILED DESCRIPTION OF THE INVENTION

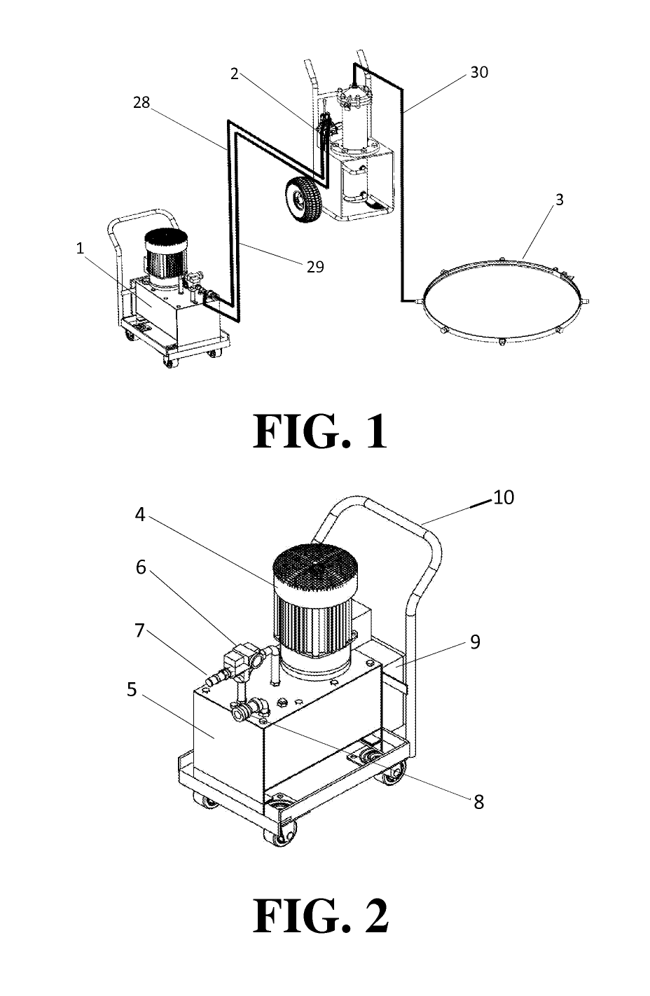

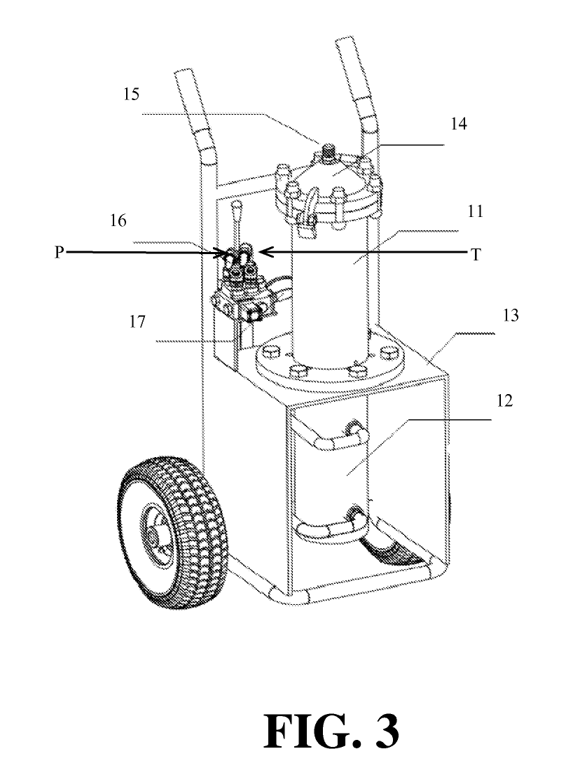

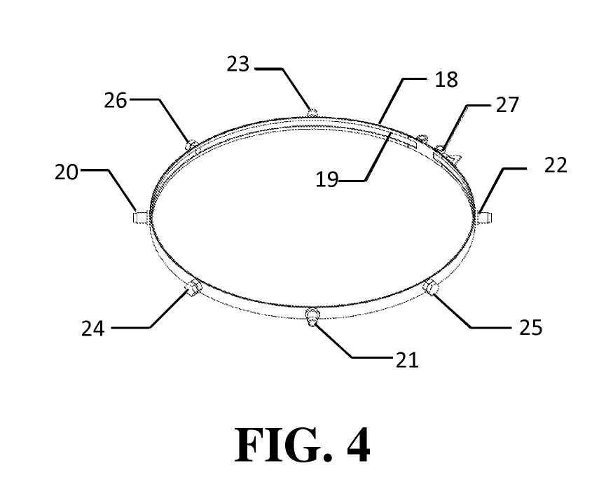

The sealing apparatus for applying corrosion prevention compound in the gap between flanges without using heat consists of 3 main units as shown in FIG. 1 including hydraulic power unit (1), compound injection cylinder unit (2), and flange belt unit (3). The hydraulic power unit (1) as shown in FIG. 2 comprises an electric motor (4) for operating a hydraulic oil pump inside a hydraulic oil tank (5), a pressure control valve (6) for controlling the pressure within a predetermined upper limit, a quick coupler (7) on the pressure control valve for connecting the hydraulic oil pipe to the pressure control valve (6) and another quick coupler (8) for connecting the hydraulic oil pipe to the hydraulic oil tank (5), and a switch box (9) for starting/stopping the operation. The whole apparatus is installed on a pushcart (10) for a convenient transportation. The pushcart is made of metal selected from steel and stainless steel provided with 4 castors, the two rear wheels being lockable. The lateral edge of the pushcart's floor is made of steel or stainless steel made into angle bar having a size of 1-2 inches. The pushcart's floor is made of steel or stainless steel having a thickness of 3-5 millimeters. The hydraulic oil tank (5) is fixed to the upper portion of the pushcart by welding or screws. A handle made from steel or stainless steel cylindrical pipe having a diameter of ¾-1 inch which is curved for convenience handling is fixed to the rear of the pushcart by welding. The compound injection cylinder unit (2) is the apparatus for injecting the corrosion prevention compound into the gap between flanges as shown in FIG. 3 comprising two integrally formed cylinders sharing one connecting rod, the upper cylinder defining the compound injection cylinder (11) integrally formed with the lower cylinder defining the hydraulic cylinder (12), the end of the connecting rod of the hydraulic cylinder being fixed to the piston of the compound injection cylinder, both cylinders being fixed to the pushcart (13) so as to be conveniently operated at flange installation sites. The pushcart's frame is made from steel or stainless steel pipes having a diameter of ¾-1 inch bended to form right angles such that its lower portion can rest securely on the ground. The vertical portions of the frame are curved to define two handles. The bottom right angle portion of the pushcart's frame is provided with a shaft attached with wheels on the left and right sides. The upper portion of the pushcart's frame is fixed to a steel or stainless steel plate having a thickness of 3-5 millimeters bended into an upside-down U-shape. The upper portion of the pushcart is punched so as to create an opening for holding and fixing the compound injection cylinder (11) and the hydraulic cylinder (12) with the pushcart using 6-10 screws. The top of the compound injection cylinder (11) is open. The bottom of the hydraulic cylinder (12) is open such that the end of the hydraulic connecting rod is vertically attached to the piston of the compound injection cylinder. The top of the compound injection cylinder (11) is provided with a lid (14) having a cone shape with an opening and a threaded coupler (15) having a diameter of ½-1 inch at its top. The base of the lid is provided with 4-6 slots for accommodating a bolt-nut assembly for fixing the lid and a bolted hinge for attaching the lid (14) to the compound injection cylinder (11). The piston in the compound injection cylinder (11) will reciprocate up and down following the movement of the hydraulic cylinder (12) when the lever at the cylinder control valve (16) is pulled. The maximum pressure value can be read from the pressure gauge (17) when the all material in the compound injection cylinder is discharged. The flange belt unit (3) is provided in several sizes as measured by the flange's diameter from 2-24 inches having 1-4 injection couplings and 1-3 ventilation openings placed alternately. The number of couplings and openings is increased as the flange's size increase so as to maximize the efficiency of the application of the corrosion prevention compound throughout the flange. A flange belt for a pipe with 2-4 inches diameter has an injection coupling and a ventilation opening. A flange belt for a pipe with 5-9 inches diameter has 3 injection couplings and 2 ventilation openings. A flange belt for a pipe with 10-24 inches diameter has 4 injection couplings and 3 ventilation openings. The FIG. 4 shows an example of a flange belt for a pipe with 10-24 inches diameter comprising a flange belt (18) made of metal selected from steel, stainless steel, aluminum and plastic internally lined with a rubber seal (19). It contains 4 injection couplings (20), (21), (22), (23) and 3 ventilation openings (24), (25), (26) for discharging the air in the gap between flanges when the compound is filled in. The ventilation openings also function as check holes through which the amount of compound filled in the gap can be checked. The assembly and disassembly of the flange belt (3) can be done by adjusting the threaded screw (27).

Method for using the sealing apparatus comprises assembling the hydraulic power unit (1), the compound injection cylinder unit (2), and the flange belt unit (3) by connecting one end of the hydraulic oil transfer pipe (28) to the quick coupler (7) of the pressure control valve (6) on the hydraulic power unit (1) and the other end to the inlet (P) of the cylinder control valve (16) on the compound injection cylinder unit (2); connecting one end of the hydraulic oil return pipe (29) to the inlet (T) of the cylinder control valve (16) on the compound injection cylinder unit (2) and the other end to the quick coupler (8) on the hydraulic power unit (1) so as to define a channel for returning the oil to the hydraulic oil tank (5); charging the corrosion prevention compound into the compound injection cylinder (11); closing the lid (14); fitting the flange belt unit (3) onto the flanges requiring the corrosion prevention compound injection; connecting one end of the hose (30) to the threaded coupler (15) on top of the lid (14) of the compound injection cylinder (11) and the other end of the hose (30) to the desired injection coupler on the flange belt unit (3); and turning on the switch on the switch box (9) and setting the desired pressure of between 50-100 bar. The hydraulic power unit (1) will in turn inject the hydraulic oil through the hydraulic oil transfer pipe (28) to the cylinder control valve (16) on the compound injection cylinder unit (2). Unless the cylinder control valve (16) is adjusted, the compound will not be injected into the gap between the flange and the flange belt unit (3) and the hydraulic oil will be returned to the tank via the hydraulic oil return pipe (29) in circulation until the apparatus is turned off. The application of corrosion prevention compound in the gap between flanges can be done by pulling the lever of the cylinder control valve (16) toward the rear of the pushcart (13). The hydraulic cylinder (12) will then drive the piston in the compound injection cylinder (11), the compound will in turn be discharged via the top of the lid (14) through the hose (30) to the injection coupling on the flange belt unit (3). After the compound flows through the ventilation opening, it should be closed by a screw. The compound injection should be continued at the preset maximum pressure for ½-2 minutes to make sure that the gap is fully filled before the injection is stopped. The hose (30) and the flange belt unit (3) are then removed. For flange belt units having more than one injection coupling and ventilation opening, after the compound flows through a ventilation opening closest to the injection coupling and the opening is closed using a screw, the hose (30) should be removed and reconnected to the next injection coupling and the injection steps should be repeated with the rest of the injection couplings. For example, after the compound is injected via the coupling (20), the compound should flow through the openings (24) and (26), after the compound is injected via the coupling (21), the compound should flow through the openings (24) and (25), after the compound is injected via the coupling (22), the compound should flow through the openings (25), and after the compound is injected via the coupling (23), the compound should flow through the openings (26).

### INDUSTRIAL APPLICATION

The sealing apparatus for applying corrosion prevention compound in the gap between flanges without using heat can be applied in the fluid transfer industry where transfer pipes are utilized and flanges are required in connecting them, wherein the heat usage must be avoided in the application of the corrosion prevention compound, particularly the natural gas and petroleum pipelines.

1. Sealing apparatus for applying corrosion prevention compound in the gap between flanges without using heat consisting of 3 units including hydraulic power unit (1), compound injection cylinder unit (2), and flange belt unit (3), the hydraulic power unit (1) controlling pressure and transferring hydraulic oil to hydraulic cylinder (12), the compound injection cylinder unit (2) injecting corrosion prevention compound into the gap between flanges via the flange belt unit (3), the hydraulic power unit (1) and the compound injection cylinder unit (2) being in communication via hydraulic oil transfer pipe (28) and hydraulic oil return pipe (29), wherein when the compound injection cylinder unit (2) receives hydraulic oil from the hydraulic power unit (1) after control valve (16) is turned, the hydraulic oil will urge the hydraulic cylinder (12) so as to press the compound injection cylinder (11) which in turn will inject the corrosion prevention compound through a hose (30) into the flange belt unit (3) and into the gap between flanges,
characterized in that the hydraulic power unit (1) comprises an electric motor (4) for operating a hydraulic oil pump inside a hydraulic oil tank (5), a pressure control valve (6) for controlling the pressure within a predetermined upper limit, a quick coupler (7) on the pressure control valve for connecting the hydraulic oil pipe to the pressure control valve (6) and another quick coupler (8) for connecting the hydraulic oil pipe to the hydraulic oil tank (5), a switch box (9) for starting/stopping the operation; wherein the whole apparatus is installed on a pushcart (10) for a convenient transportation, the pushcart being made of metal selected from steel and stainless steel provided with 4 castors, the two rear wheels being lockable, the lateral edge of the pushcart's floor being made of steel or stainless steel made into angle bar having a size of 1-2 inches, the pushcart's floor being made of steel or stainless steel having a thickness of 3-5 millimeters, the hydraulic oil tank (5) being fixed to the upper portion of the pushcart by welding or screws, a handle made from steel or stainless steel cylindrical pipe having a diameter of ¾-1 inch which is curved for convenience handling being fixed to the rear of the pushcart by welding;
the compound injection cylinder unit (2) comprises two integrally formed cylinders sharing one connecting rod, the upper cylinder defining the compound injection cylinder (11) integrally formed with the lower cylinder defining the hydraulic cylinder (12), the end of the connecting rod of the hydraulic cylinder being fixed to the piston of the compound injection cylinder, both cylinders being fixed to the pushcart (13) so as to be conveniently operated at flange installation sites, the pushcart's frame being made from steel or stainless steel pipes having a diameter of ¾-1 inch bended to form right angles such that its lower portion can rest securely on the ground, the vertical portions of the frame being curved to define two handles, the bottom right angle portion of the pushcart's frame being provided with a shaft attached with wheels on the left and right sides, the upper portion of the pushcart's frame being fixed to a steel or stainless steel plate having a thickness of 3-5 millimeters bended into an upside-down U-shape, the upper portion of the pushcart being punched so as to create an opening for holding and fixing the compound injection cylinder (11) and the hydraulic cylinder (12) with the pushcart using 6-10 screws, the top of the compound injection cylinder (11) being open, the bottom of the hydraulic cylinder (12) being open such that the end of the hydraulic connecting rod is vertically attached to the piston of the compound injection cylinder, the top of the compound injection cylinder (11) being provided with a lid (14) having a cone shape with an opening and a threaded coupler (15) having a diameter of ½-1 inch at its top, the base of the lid being provided with 4-6 slots for accommodating a bolt-nut assembly for fixing the lid and a bolted hinge for attaching the lid (14) to the compound injection cylinder (11), wherein the piston in the compound injection cylinder (11) will reciprocate up and down following the movement of the hydraulic cylinder (12) when the lever at the cylinder control valve (16) is pulled and the maximum pressure value can be read from the pressure gauge (17) when the all material in the compound injection cylinder is discharged; and
the flange belt unit (3) comprises a flange belt (18) made of metal selected from stainless steel, steel, aluminum or plastic, its inner surface being lined with a rubber seal (19), its assembly and disassembly being done by adjusting a threaded screw (27), the flange belt unit (3) is provided in several sizes as measured by the flange's diameter from 2-24 inches including a flange belt for a pipe with 2-4 inches diameter having an injection coupling and a ventilation opening, a flange belt for a pipe with 5-9 inches diameter having 3 injection couplings and 2 ventilation openings, and a flange belt for a pipe with 10-24 inches diameter having 4 injection couplings (20), (21), (22), (23) and 3 ventilation openings (24), (25), (26).

2. Method for using the sealing apparatus for applying corrosion prevention compound in the gap between flanges without using heat according to claim 1 comprising assembling the hydraulic power unit (1), the compound injection cylinder unit (2), and the flange belt unit (3) by connecting one end of the hydraulic oil transfer pipe (28) to the quick coupler (7) of the pressure control valve (6) on the hydraulic power unit (1) and the other end to the inlet (P) of the cylinder control valve (16) on the compound injection cylinder unit (2); connecting one end of the hydraulic oil return pipe (29) to the inlet (T) of the cylinder control valve (16) on the compound injection cylinder unit (2) and the other end to the quick coupler (8) on the hydraulic power unit (1) so as to define a channel for returning the oil to the hydraulic oil tank (5); charging the corrosion prevention compound into the compound injection cylinder (11); closing the lid (14); fitting the flange belt unit (3) onto the flanges requiring the corrosion prevention compound injection; connecting one end of the hose (30) to the threaded coupler (15) on top of the lid (14) of the compound injection cylinder (11) and the other end to the desired injection coupler on the flange belt unit (3); and turning on the switch on the switch box (9) and setting the desired pressure of between 50-100 bar, then the hydraulic power unit (1) will inject the hydraulic oil through the hydraulic oil transfer pipe (28) to the cylinder control valve (16) on the compound injection cylinder unit (2); the application of corrosion prevention compound in the gap between flanges can be done by pulling the lever of the cylinder control valve (16) toward the rear of the pushcart (13), the hydraulic cylinder (12) will drive the piston in the compound injection cylinder (11), the compound will be discharged via the top of the lid (14) through the hose (30) to the injection coupling on the flange belt unit (3); for flange belt having one injection coupling and one ventilation opening, after the compound flows through the ventilation opening, closing it by a screw; continuing the compound injection at the preset maximum pressure for ½-2 minutes and stopping the injection; removing the hose (30) and the flange belt unit; for flange belt having more than one injection coupling and ventilation opening, after the compound flows through a ventilation opening closest to the injection coupling and the opening is closed using a screw, removing the hose (30) and reconnecting it to the next injection coupling and repeat the injection steps with the rest of the injection couplings
